(19) United States
(12) Patent Application Publication
(10) Pub. No.: US 2011/0205833 A1
(43) Pub. Date: Aug. 25, 2011

(54) Device

(75) Inventor: Paul Thuerwaechter, Sulzberg (DE)

(73) Assignee: Thuerwaechter GmbH & Co. KG, Sulzberg (DE)

(21) Appl. No.: 12/932,118

(22) Filed: Feb. 17, 2011

(30) Foreign Application Priority Data
Feb. 21, 2010 (DE) 10 2010 000 489.8

(51) Int. Cl. B01F 13/00

(52) U.S. Cl. 366/198; 366/197; 366/207

(57) ABSTRACT

A device for intimately mixing the content of substrate containers, includes a stirring mechanism made up of a drive motor, a connecting rod and a stirring propeller at the end of the connecting rod remote from the drive motor. A support mechanism is provided for accepting the weight of the stirring mechanism.

### CROSS REFERENCE TO RELATED APPLICATIONS

Applicant claims priority under 35 U.S.C. 119 of German Application No. 10 2010 000 489.8 filed Feb. 21, 2010, the disclosure of which is incorporated by reference.

### BACKGROUND OF THE INVENTION

1. Field of the Invention

The invention relates to a device for intimately mixing the content of substrate containers, comprising a stirring mechanism consisting of a drive motor, a connecting rod and a stirring propeller at the end of the connecting rod remote from the drive motor.

2. Description of the Related Art

Various stirring mechanisms of this mode of construction, particularly for intimately mixing liquid manure, but also particularly in biogas plants for intimately mixing the material to be gassified, are known.

It is common to all these stirring mechanisms that these can be mounted only at a fixed, especially load-bearing basins. Use at open basins or basins covered by tarpaulins is neither provided nor possible.

### SUMMARY OF THE INVENTION

The present invention therefore has the object of proposing a device for intimately mixing the content of substrate containers, comprising a stirring mechanism consisting of a drive motor, a connecting rod and a stirring propeller at the end of the connecting rod remote from the drive motor, which is also usable with shallow basins or basins covered by tarpaulins.

According to the invention this object is fulfilled in that a support device for accepting the weight of the stirring mechanism is provided.

The stirring mechanism is thus held and guided in position.

It is also very advantageous if a lead-through is provided which is insertable into a non-load-bearing cover of the substrate container and through which the stirring mechanism projects.

A lead-through which is sealed and movable, but which nevertheless does not have to accept the weight of the stirring mechanism, is thus created. It is also conceivable for the cover to be held by the lead-through in a predetermined position. In addition, it is conceivable to be able to create flexible fermentation containers through the walls of which the stirring mechanism projects.

Similarly, it is very advantageous if the lead-through is connected with the support device.

Transmission of forces to the cover of the substrate container is thereby avoided.

A very advantageous embodiment of the invention is also present if the stirring mechanism is pivotable and/or displaceable relative to the support device and/or the lead-through and/or if the stirring mechanism is pivotable about a fulcrum which lies at least substantially in the lead-through.

Relative movements between the stirring mechanism and the cover are thereby largely avoided. In addition, an optimum movability of the stirring mechanism in the substrate container is ensured.

According to the invention it has also proved extremely advantageous if the support device is constructed as a support arm, which can have an additional support strut relative to the support base.

A further improvement in stability of the support device is thus guaranteed. In addition, horizontal loads are thereby safety accepted by the construction.

A further very advantageous embodiment of the invention is also present when the support device has a longitudinally adjustable strut for setting the vertical and/or horizontal position of the stirring mechanism and/or of the articulation point of the stirring mechanism.

Thus, not only the position of the articulation point of the stirring mechanism, but also that of the lead-through and the position of the stirring mechanism in the container can be set.

According to a further very advantageous development of the invention the stirring mechanism can also be detachably connected with the support device and the lead-through.

As a result, not only is subsequent installation of the stirring mechanism in existing substrate containers facilitated, but also servicing and/or exchange of parts can be carried out very easily.

According to the invention it is also extremely advantageous if the lead-through has a liquid-tight and/or gas-tight sealing relative to the connecting rod.

The substrate container can thus be tightly closed off relative to the environment. The use of the stirring mechanism is also conceivable with substrate containers having a cover which in operation is lifted by the arising gas and at least slightly inflated.

According to the invention it is also extremely advantageous if the connecting rod is constructed to be longitudinally displaceable and/or adjustable in length.

A very large range within the substrate container can thus be reached. A good level of intimate mixing is ensured.

A further very advantageous embodiment is also present when an at least partly encircling protective device is associated with the propeller.

It is thereby possible on the one hand to prevent the propeller from being able to directly rest on the base of the container and on the other hand to ensure that the propeller does not possibly damage container walls, which can be a problem particularly in the case of flexible walls.

### BRIEF DESCRIPTION OF THE DRAWINGS

The invention is explained in the following by way of an exemplifying embodiment, in which connection:

FIG. 1 shows a schematic illustration of a stirring mechanism according to the invention, which is arranged in a substrate with the flexible cover,

FIG. 2 shows a detail view of the support device with lead-through and drive motor,

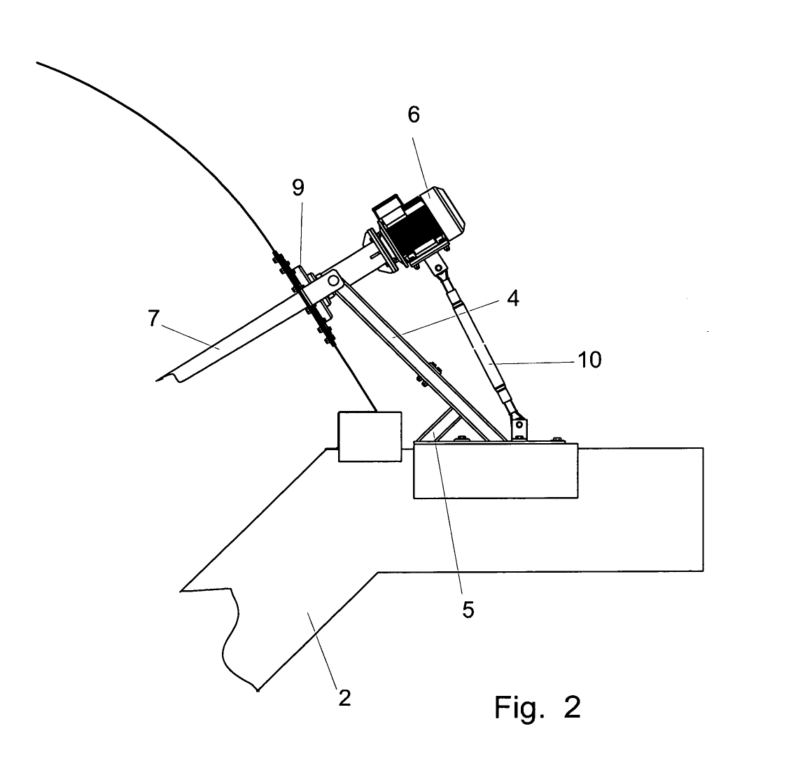

FIG. 3 shows an exploded illustration of the lead-through with the support device and

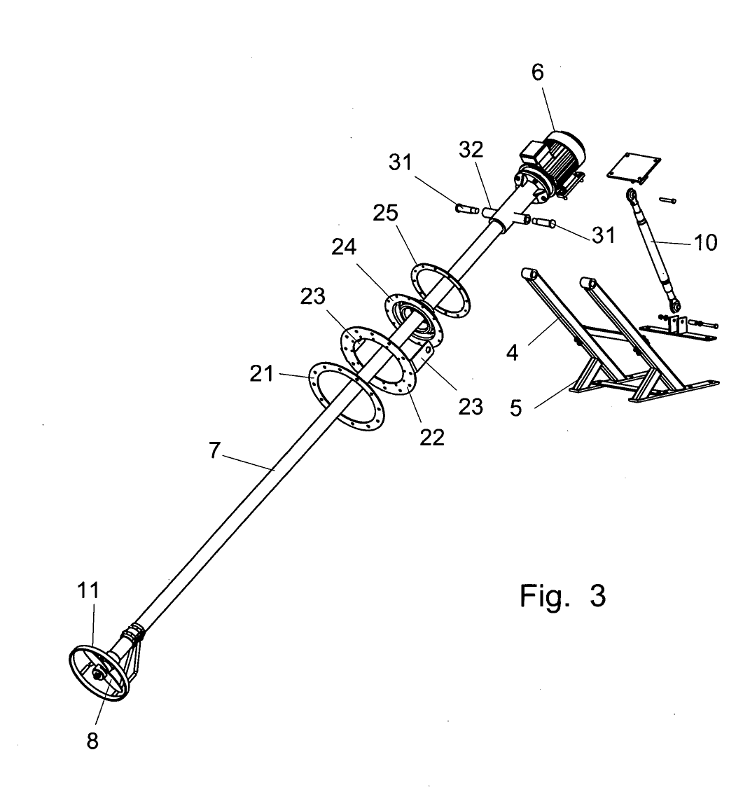

FIG. 4 shows a detail view of the stirring propeller.

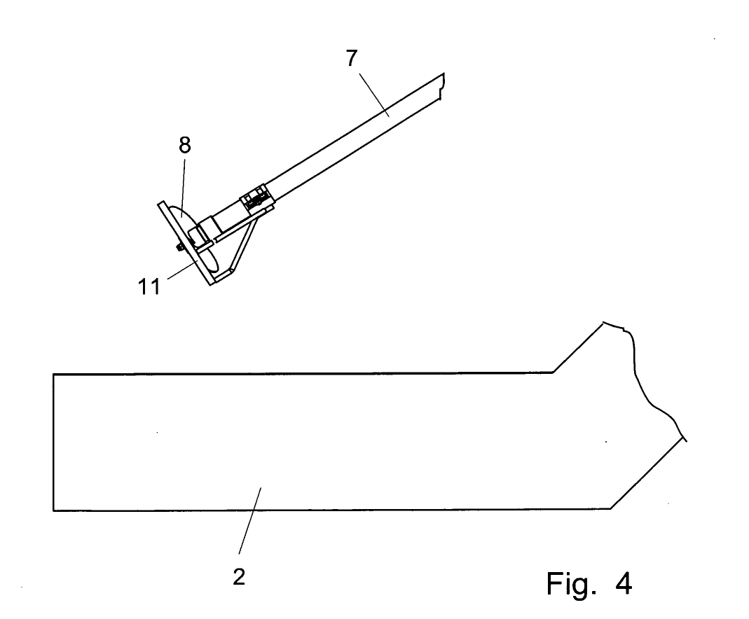

### DETAILED DESCRIPTION OF THE PREFERRED EMBODIMENTS

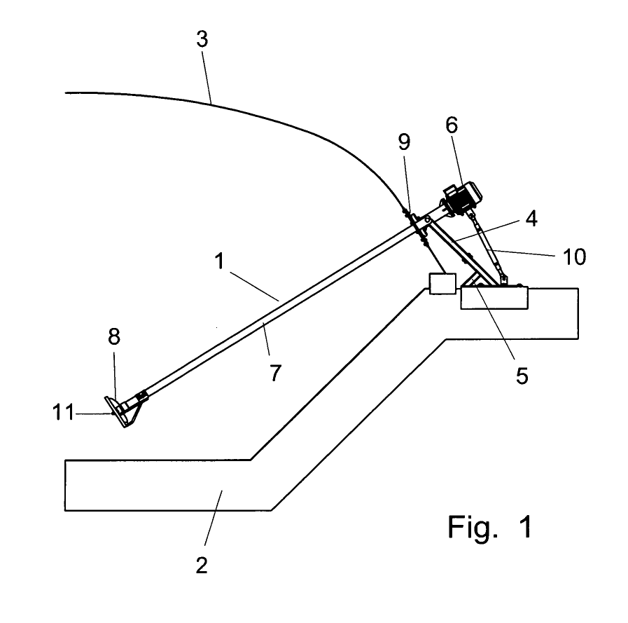

A stirring mechanism for thorough mixing of substrate in containers, particularly in fermentation containers, is denoted in FIG. 1 by 1. Such a fermentation container is constructed from a base gutter 2, which usually drops down at an inclination towards the center, and a flexible cover 3. The cover 3 is gas-tightly connected with the base matter 2. Such containers are frequently used for producing biogas from biomasses. In that case the substrate is introduced into the base gutter 2 at an end of the container and the residue is removed again at the other end after the gasification process.

In that case, however, deposits of substrate arise in the base gutter 2, so that insufficient gasification can take place.

In order to prevent this, one or more stirring mechanisms are provided at the edge of the base gutter. These are mounted on a support device 4 which is capable of accepting the load of the respective stirring mechanism 1. The support device 4 can in that case be constructed as a strut, which can have an additional support 5 so that the support device 4 is also capable of accepting horizontal forces.

The stirring mechanism 1, which substantially consists of a drive motor 6, a connecting tube 7 and a stirring propeller 8 arranged at the end of the connecting tube 7 remote from the drive motor 6, rests on the support device 4.

The stirring mechanism 1 projects by its stirring propeller 8 into the substrate in the base gutter 2. For that purpose the connecting tube 7 is guided through the cover 3 and sealed off there by a lead-through 9.

The lead-through 9 is in that case so arranged that this is provided at least in the immediate vicinity of the support device 4. Thus, on the one hand movements of the cover 3 during movement of the stirring mechanism 1 are at least substantially reduced. On the other hand, the cover is also held by the lead-through when, for example, the substrate container is newly charged.

In the ideal case the support device 4 directly engages the lead-through 9. The fulcrum of the stirring mechanism 1 then lies quite precisely in the plane of the cover within the lead-through 9.

In order to be able to predetermine the position of the propeller in the substrate and/or in order to be able to predetermined a defined movement path a securing and supporting strut 10 can be provided, which in the region of the lower end engages the support device 4 and by its other end can engage, for example, the drive motor 4.

The spacing between drive motor and base is maintained by this support strut 10.

The propeller 8 is driven by the drive motor 6 by way of a shaft (not illustrated). This shaft runs in the connecting tube 7 and is gas-tightly sealed relative thereto by, for example, shaft sealing rings so that no gas is able to escape from the container by way of the connecting tube. In addition, penetration of the substrate into the connecting tube 7 is also thus prevented.

Provided around the propeller 8 is a protector which covers at least a sub-region of the propeller circumference and thus prevents the propeller from being able to directly rest on the base gutter 2 or the propeller 8 from being able to damage the cover 3 if this is lifted out of the substrate or if the cover 3 drops.

The protector 11 can in that case be constructed as an encircling ring fastened to the connecting tube 7.

The lead-through 9 substantially consists of an inner ring 21, a support ring 22 at which fastening straps 23 connectible with the support device 4 are formed, a flexible seal 24 and an outer ring 25. An absolutely tight connection between connecting tube 7 and the cover 3 is created by this construction.

The inner diameter of the inner ring 21 and the support ring 22 should be at least as large as the diameter of the protector 11 around the propeller 8, so that the stirring device 1 can be simply withdrawn from the container without the container having to be emptied or entered, whereby servicing operations can then be performed very easily.

In order to withdraw the stirring device 1 the outer ring 25 is then simply unscrewed and removed together with the seal 24.

The lead-through 9 can be connected, by way of example, with the support device 4 by way of straps 23 and by a bolt 31. The bolt 31 can, for example, simultaneously engage in a further mounting device 32, which is arranged at the connecting tube 7 and which defines the insertion position of the stirring device 1 and at the same time transmits the weight of the stirring device 1 to the support device 4.

It is also conceivable for several bolts 31 to be able to be provided.

In order to install the stirring device 1 in existing containers the support device 4 is mounted and thus determines the position of the lead-through 9 at the cover 3. An appropriate hole can then be formed in the cover 9. The inner ring 21 and support ring 22 are thereupon mounted. The support ring 22 can already be connected with the support device 4 by way of the straps 23 and thus the cover 3 held in the later position. Further lead-throughs 9 can now be similarly mounted.

Only subsequently are the stirring devices 1 introduced into the container via the openings of the lead-throughs 9. The stirring device 1 is connected with the support device by, for example, bolts 31. The seal 24 and the outer ring 25 are thereafter connected with the inner ring 21 and the support ring 22 and thus the cover closed again.

The seal 24 in that case bears tightly against the connecting tube 7.

The seal 24 can, for example, be constructed as a rubber sleeve. However, it is also conceivable for an at least partly flexible steel seal to be provided.

What is claimed is:

1. A device for intimately mixing the content of substrate containers, comprising a stirring mechanism made up of a drive motor, a connecting rod and a stirring propeller at the end of the connecting rod remote from the drive motor, wherein a support mechanism for accepting the weight of the stirring mechanism is provided.

2. The device according to claim 1, wherein a lead-through is provided which is insertable into a non-load-bearing cover of the substrate container and through which the stirring mechanism projects.

3. The device according to claim 2, wherein the lead-through is connected with the support device.

4. The device according to claim 1, wherein the stirring mechanism is pivotable and/or displaceable relative to the support device and/or the lead-through and/or wherein the stirring mechanism is pivotable about a fulcrum lying at least substantially in the lead-through.

5. The device according to claim 1, wherein the support device is constructed as a support arm which can have an additional support strut relative to the support base.

6. The device according to claim 1, wherein the support device comprises a strut adjustable in length for adjusting the vertical and/or horizontal position of the stirring mechanism and/or of the articulation point of the stirring mechanism.

7. The device according to claim 1, wherein the stirring mechanism is detachably connected with the support device and the lead-through.

8. The device according to claim 1, wherein the lead-through has a liquid-tight and/or gas-tight sealing relative to the connecting rod.

9. The device according to claim 1, wherein the connecting rod is constructed to be longitudinally displaceable and/or adjustable in length.

10. The device according to claim 1, wherein an at least partly encircling protective device is associated with the propeller.
